(19) United States
(12) Patent Application Publication
(10) Pub. No.: US 2009/0047981 A1
(43) Pub. Date: Feb. 19, 2009

(54) METHOD AND SYSTEM FOR DELIVERING MESSAGES

(76) Inventor: Sunil Khanna, Singapore (SG)

Correspondence Address: FROMMER LAWRENCE & HAUG, 745 FIFTH AVENUE- 10TH FL., NEW YORK, NY, 10151, US

(21) Appl. No.: 11/838,494

(22) Filed: Aug. 14, 2007

(51) Int. Cl. H04Q 7/20; G06F 15/16; H04Q 7/22

(52) U.S. Cl. 455/466; 455/414.1; 719/313

(57) ABSTRACT

Provided is a method for delivering a Short Messaging Service (SMS) message and/or a Multimedia Messaging Service (MMS) message and/or an Enhanced Messaging Service (EMS) message from an initiator device to an end user device. Also provided is a telecommunication system for delivering a Short Messaging Service (SMS) message and/or a Multimedia Messaging Service (MMS) message and/or and enhanced Messaging Service (EMS) message from an initiator device to an end user device.

### FIELD OF THE INVENTION

The present invention relates to a reliable system and method for delivering a Short Messaging Service (SMS) message and/or a Multimedia Messaging Service (MMS) message and/or an Enhanced Messaging Service (EMS) message from an initiator device to an end user device where the initiator i.e. who sends the message determines the delivery date and time of the message.

### BACKGROUND OF THE INVENTION

At present, the use of wireless communication devices is common and is enormously increasing. It is one of the fastest growing and most demanding applications ever. Wireless Communication based on mobile phones has been very commonly known. But, now we are aware that the need for using sophisticated functions in the wireless devices is also increasing. One of these functions may be sending and/or receiving short text messages by using Short Message Service (SMS). SMS is a telecommunication service, which allows the immediate sending of short text messages and utilizes the Short Message Service Center (SMSC) which stores and forwards short messages to the mobile subscriber.

A wireless communication system is composed of a plurality of Mobile Service Centers (MSC) and an integrated Visitor Location Register (VLR). The MSC is in communication with at least one Base Station Controller which in turn is connected to several Base transceiver stations (BTS). The BTS is a physical equipment which may be a radio tower that provides radio coverage to the geographical part of the cell for which it is responsible. A mobile subscriber can send a point-to-point or point to multi point SMS message to another mobile subscriber. Normally the message will be delivered immediately or as soon as possible from time to time with some small delay depending on the capacity of the Short Messaging Service Center (SMSC) and whether or not the Mobile Subscriber (MS) is active. If the mobile subscriber is not active e.g. if the mobile is in the “OFF” position, then the message is stored in the SMSC for a certain amount of time and the message gets delivered as and when the receiving mobile subscriber is active e.g. when the mobile is in the “ON” position. After the MSC sends the message to the mobile subscriber, a delivery report is sent from the MSC to the SMSC and then to the initiator confirming that the message has been sent.

The major drawback of the existing system is that the initiator of the message does not have any control over the delivery time of the text messages. In such a case, the initiator has to send the message to the recipient on the date and time of the occasion at which he wants the message to be delivered so that the message is delivered as soon as possible. Moreover, the sender cannot put any priority to the message or any delay in delivering the message according to his choice.

Another drawback of the existing system is that the message may not reach the terminating mobile subscriber after being stored in the SMSC for a certain amount of time. This usually happens when there is excessive load on the SMSC.

Another drawback of the present system is that the initiator mobile subscriber cannot modify the message once he has sent it to the receiver i.e. once the message is sent from the person's mobile, it gets stored in the SMSC and it gets delivered according to the load. An improvement in the present technology is that there are certain software available which are downloadable on compatible mobile handsets such as: SpeedSMS, SMSmachine etc. which allow the initiator to define the date and time of delivery of the message wherein the initiator sends the message whenever he wishes to and specifies the date and time of delivery of the message. The message gets stored in the handset itself till that desired date and time of delivery occurs. Here in this case, the software has to be downloaded from the World Wide Web and even these software have a disadvantage that if the mobile handset of the initiator gets lost or incurs any such losses before any delivery date or time of the message, the message gets lost and hence, it is not delivered to the terminating mobile subscriber.

### SUMMARY OF THE INVENTION

In order to overcome the above mentioned drawbacks, the present invention has been developed and it relates to a reliable system and method for delivering a Short Messaging Service (SMS) message and/or a Multimedia Messaging Service (MMS) message and/or an Enhanced Messaging Service (EMS) message from an initiator device to an end user device where the initiator i.e. who sends the message determines the delivery date and time of the message. Particularly, the present invention enables the initiator to control the time of delivery of an SMS message by storing the message in the Short Message Service Center (SMSC)/MMSC and getting the message delivered at a desired date and time. There are no constraints to the number of messages being sent by the initiator or the sender and the initiator can send an instruction for amending the message and even the date and time of delivery of the message can be amended, with the only obvious condition that the instruction for amending or deleting the message has to be provided before the delivery date and time of the original message.

The present invention is directed to a method for delivering a Short Messaging Service (SMS) message and/or a Multimedia Messaging Service (MMS) message and/or an Enhanced Messaging Service (EMS) message from an initiator device to an end user device, said method comprising the steps of:
receiving by a short message service centre (SMSC) the SMS and/or the EMS message and/or receiving by a Multimedia Messaging service centre (MMSC) the MMS comprising a service code and a user-defined date and time for delivering the message to said end user device from the initiator device;
allocating an unique identification number to the message thus received;
sending a message to the initiator device incorporating at least the unique identification number;
storing the message with at least the unique identification number; and
delivering by the SMSC/MMSC the message at said user-defined date and time to the end user device.

In an embodiment of the invention, the unique identification number is allocated by the SMSC/MMSC or by a Service Centre (SC) operatively coupled to the SMSC/MMSC.

In another embodiment of the invention, if the unique identification number is allocated by the Service Centre, the step of allocating identification number comprises the steps: transferring the SMS and/or the MMS and/or the EMS message from the SMSC/MMSC to the SC; allocating the unique identification number to the message by the Service Centre; generating a message incorporating at least the unique identification number by the Service Centre; and transmitting the message thus generated in step (c) to the SMSC/MMSC.

According to another embodiment of the invention, communication between the SMSC/MMSC and SC are based on one or more of the Web based protocols.

According to one more embodiment of the invention, if the unique identification number is allocated by the SMSC/MMSC, the step of sending a message to the initiator incorporating at least the unique identification number further comprises the step of generating the message incorporating at least the unique identification number by the SMSC/MMSC.

According to one more embodiment of the invention, wherein in step (d), the message with at least the unique identification number is stored at the SMSC/MMSC or at the SC.

According to still another embodiment of the invention, wherein messages thus stored are categorized on the basis of the initiator device.

In one more embodiment of the invention, the method further comprises the step of displaying the message thus stored at the SMSC/MMSC or at the SC.

In yet another embodiment of the invention, the message thus stored at the SMSC/MMSC or at the SC is displayed on World Wide Web.

According to another embodiment of the invention, the messages displayed on the World Wide Web are categorized on the basis of the initiator device.

According to yet another embodiment of the invention, the messages are displayed to be contained in a outbox waiting to be delivered, the outbox being initiator device specific.

According to still another embodiment of the invention, the method further comprises the step of receiving instruction for amending the stored message.

According to another embodiment of the invention, the instructions for amending the stored message is receivable from the same initiator device or a device which different from the initiator device.

According to one more embodiment of the invention, wherein the instructions for amending a stored message is accompanied by the unique identification number of the stored message.

According to another embodiment of the invention, the method further comprising the step of storing an amended message and deleting an original message.

According to still another embodiment of the invention, if instruction for amending the stored message is received, delivering the amended message by the SMSC/MMSC at said user-defined date and time to the end user device.

According to yet another embodiment of the invention, if an instruction for deleting an original message is received, the stored message is deleted in place of step (e).

According to an embodiment of the invention, the present invention relates to a telecommunication system for delivering a Short Messaging Service (SMS) message and/or a Multimedia Messaging Service (MMS) message and/or an Enhanced Messaging Service (EMS) message from an initiator device to an end user device, said telecommunications system comprising:
a Short Messaging Service Center (SMSC) for receiving the Short Messaging Service (SMS) message and/or an Enhanced Messaging Service (EMS) message and/or a
Multimedia Messaging Service Center for receiving the Multimedia Messaging Service (MMS) message from an initiator device; for sending a confirmation message to the initiator device with at least an unique identification number and for delivering the message at the user defined date and time to the end user device;
a processor configured for allocating the unique identification number to the message thus received by the said SMSC/MMSC; and
a memory for storing the said message with at least the unique identification number until the said user defined date and time is reached; wherein the processor and the memory are in operational communication with the SMSC/MMSC.

According to another embodiment of the invention, the processor and the memory form part of the said SMSC/MMSC.

According to one more embodiment of the invention, the SMSC/MMSC comprises at least one receiver for receiving the said message from the initiator device and at least one transmitter for transmitting the said message to the end user device and for transmitting the message incorporating the unique identification number to the initiator device, said receiver and transmitter being in operational communication with the said processor which generates the message incorporating the unique identification number.

According to still another embodiment of the present invention, the processor and the memory form part of a Service Center (SC) which is in communication with the said SMSC/MMSC.

In yet another embodiment of the invention, the SMSC/MMSC comprises of at least one receiver for receiving the message from the initiator device;
a data processor in communication with the receiver for receiving the said message, communicating the same to the processor contained in the Service Center and in response receive the message incorporating the unique identification number from the Service Center; and
a transmitter in communication with the data processor for transmitting the message incorporating the unique identification number to the initiator device.

According to yet another embodiment of the invention, the communication between the data processor contained in the SMSC/MMSC and the processor contained in the Service Center is based on one or more web based protocols and the data processor contained in the SMSC/MSC is configured to convert the Short Messaging Service (SMS) message and/or a Multimedia Messaging Service (MMS) message and/or an Enhanced Messaging Service (EMS) message into a web based message and vice versa.

According to still another embodiment of the invention, wherein the processor is in communication with a web server for displaying the message thus stored at the SMSC/MMSC or at the SC on the World Wide Web.

In still another embodiment of the invention, the Web Server is connectable to the initiator device for receiving further messages.

### BRIEF DESCRIPTION OF THE DRAWINGS

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the present invention wherein:

FIG. 1 illustrates a schematic representation of method for transmitting messages at a desired date and time in accordance with an embodiment of the present invention.

FIG. 2 illustrates another schematic representation of the method for transmitting messages in accordance with another embodiment of the present invention.

FIG. 3 depicts the various components of the telecommunication system in accordance with an embodiment of the invention.

FIG. 4 shows the components of the telecommunication system according to another embodiment of the invention.

### DETAILED DESCRIPTION

Before describing in detail, the embodiments that are in accordance with the present invention, it should be observed that the embodiments reside primarily in combinations of method steps for transmitting Short Messaging Service (SMS) message and/or a Multimedia Messaging Service (MMS) message and/or an Enhanced Messaging Service (EMS) message at a desired date and time. The initiator can send the message along with the date and time on which he wishes his message to be delivered. For example, if a person ‘A’ wants to send a birthday message to his friend whose birthday is due for some day, then for example—he can send the message today itself i.e. 16 Jun. 2007 and specify that he wants the message to be delivered on 19 Jun. 2007 at a specific time. The message contains the text along with the date and time on which he wants the message to be received.

Accordingly, the method steps have been represented where appropriate by conventional symbols in the drawings, showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a process, method that comprises a list of steps does not include only those steps but may include other steps not expressly listed or inherent to such process, method. An element proceeded by “comprises . . . a” does not, without more constraints, preclude the existence of additional identical steps in the process or method that comprises the steps.

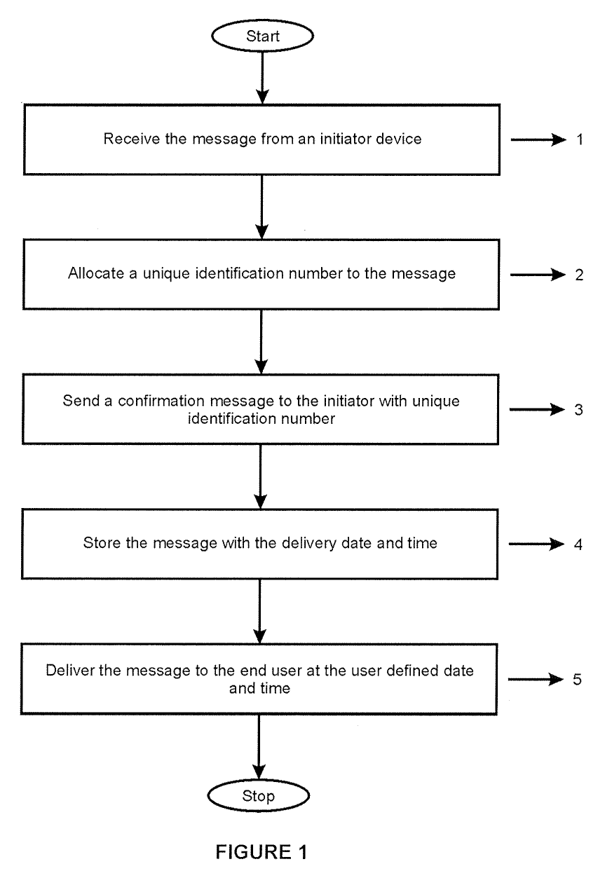

As described in the preceding paragraphs and illustrated in FIG. 1, the method for delivering messages can be described as follows: receiving by a short message service centre (SMSC), the SMS and/or the EMS message and/or receiving by a Multimedia Messaging Service Center (MMSC) the MMS comprising a service code and a user-defined date and time for delivering the message to said end user device from the initiator device (1); allocating an unique identification number to the message thus received in the above step (2); sending a message to the initiator device incorporating at least the unique identification number (3); storing the message with at least the unique identification number (4); and delivering by the SMSC/MMSC the message at said user-defined date and time to the end user device(S).

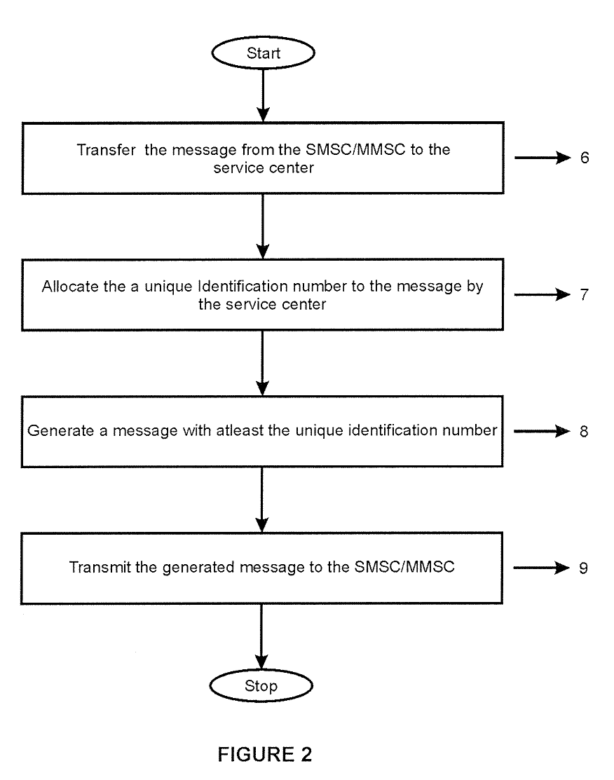

Depending upon the nature of message being sent i.e. an SMS or an EMS or an MMS message, the above mentioned steps can be implemented as follows: Firstly, the SMSC/MMSC receives the message from the initiator wherein the message comprises the date and time of delivery as to when the initiator or the sender wishes to deliver the message to the end user. The message includes an individual service code which is an identity indicating that the sender is requesting for a deferred delivery of the message. After the SMSC/MMSC receives the message, a unique identification number is allocated to each of the message thus received by the SMSC/MMSC or by a Service Center operatively coupled to the SMSC which is known as SMINDER Service Center (SSC). On allocating the unique identification number to the message, a confirmation message along with at least the allocated unique identification number is generated and then sent to the initiator device from the SMSC/MMSC. The allocated unique identification number can be used by the initiator device for later purposes such as: for reviewing the pending messages, for modifying the messages or for deleting the existing messages. The next step includes storing the message in the SMSC/MMSC or the SMINDER Service Center with the unique identification number and the date and time of delivery of the message. And, even if the SMSC does not store the unique identification number, the date and time of delivery of each of the message is unique for each of the message being stored in the SMSC. The final step is delivering the message to the end user from the SMSC at the date and time defined by the initiator device. Now, if we consider the situation that the unique identification number is allocated by the SMINDER Service Center coupled to the SMSC/MMSC, then the method of allocation of a unique identification number involves the following steps with reference to FIG. 2: transferring the SMS and/or the MMS and/or the EMS message from the SMSC/MMSC to the Service Center (5); allocating a unique identification number to the message thus received by the Service Centre from the SMSC/MMSC (6); generating a message incorporating at least the unique identification number allocated by the Service Centre (7); and transmitting the message thus generated in the previous step to the SMSC/MMSC (8).

The method steps according to the above mentioned embodiment can be explained as follows: Since, the message is first sent to the SMSC/MMSC from the initiator device, the said message has to be transferred from the SMSC/MMSC to the Service Center for allocation of unique identification number. Each of the messages is allocated a unique identification number by the Service Center and a confirmation message with at least the unique identification number is generated and transmitted to the SMSC/MMSC for sending it to the initiator device. Meanwhile, the message is stored in the memory within the said Service Center and finally the message is delivered to the end user.

The SMSC/MMSC and the Service Center communicate with each other through various kinds of web protocols or interfaces. The various kinds of protocols through which the communication can take place include: Hypertext Transfer Protocol (HTTP), Secure Hypertext Transfer Protocol (SHTTP), Simple Message Transfer Protocol (SMTP), Internet Message Access Protocol (IMAP), Extensible Messaging and Presence Protocol (XMPP) etc.

If we consider the other situation where the unique identification number is to be allocated by the SMSC/MMSC, then the step of incorporating at least the unique identification number comprises generation of the confirmation message with the unique identification number to be performed by the SMSC/MMSC.

The messages thus stored in the SMSC/MMSC or in the Service Center are categorized on the basis of the initiator device i.e. through the World Wide Web or through a personalized mobile number. The stored messages with the date and time of delivery of the messages is displayed on the World Wide Web and categorized on the basis of the initiator device and it enables the initiator to review his pending messages and modify or delete the messages before the delivery of the original messages at the user defined date and time. The messages waiting to be delivered are contained in an outbox which the sender or the initiator can access whenever and from wherever he wants to since the method is web enabled.

In another embodiment of the invention, the method of transmitting messages involves amending or deleting the stored messages before the final delivery of the messages to the end user.

By way of example, the instruction for performing the various steps can be explained as follows: The content of the message may contain a command line with instructions at the beginning of the message as follows:
*cre#01#+65123123123xxxx#201001#May07*message-content
   The general format is: *3-character-command-code#sequence number #subscriber-number-of-designee #time #date*message-content
   The 3 character command (mnemonic) can be in any form one of which can be for example:
   cre=create message for delivery
   del=delete message earlier created (use seq number to select)
   mod=modify message earlier created (use seq number to select)

The method involves the following steps: Firstly, the instruction for amending the stored message is received in the SMSC from the initiator device. Since, the instruction for amending a stored message is received along with the allocated unique identification number, the instruction can be received from the same initiator device or from some other device.

According to another embodiment of the invention, the amended message is stored in the SMSC/MMSC or in the SMINDER Service Center and automatically the original message gets deleted. The amended message may contain a new date and time of delivery of message or the initiator may want to retain the same date and time of delivery. The amended message gets stored in the SMSC/MMSC or in the SMINDER Service Center till the date and time of delivery of the message occurs. Finally, the amended message gets delivered from the SMSC/MMSC to the end user device at the user defined date and time.

According to another embodiment of the invention, the method also comprises receiving instructions for deleting the original message. Such an instruction may be received in the following manner:

*del#01#+65123123123xxxx#201001#May07*message-content

Such an instruction sent to the SMSC/MMSC from the initiator device may at least contain the unique identification number and the date and time of delivery of the original message. The SMSC/MMSC on receiving such an instruction deletes the stored message and as a result, the message is not delivered to the end user device. Such an instruction for deleting the original message can be made only after the initiator receives the unique identification number from the SMSC.

The present invention relates to a telecommunication system for delivering a Short Messaging Service (SMS) message and/or a Multimedia Messaging Service (MMS) message and/or an Enhanced Messaging Service (EMS) message from an initiator device (20) to an end user device (50), said telecommunications system comprising:
a Short Messaging Service Center (SMSC) (80) for receiving the Short Messaging Service (SMS) message and/or an Enhanced Messaging Service (EMS) message and/or a Multimedia Messaging Service Center for receiving the Multimedia Messaging Service (MMS) message from an initiator device (20); for sending a confirmation message to the initiator device (20) with at least an unique identification number and for delivering the message at the user defined date and time to the end user device (50);
a processor (30) configured for allocating the unique identification number to the message thus received by the said SMSC/MMSC (80); and
a memory (40) for storing the said message with at least the unique identification number until the said user defined date and time is reached;
wherein the processor (30) and the memory (40) are in operational communication with the SMSC/MMSC (80).

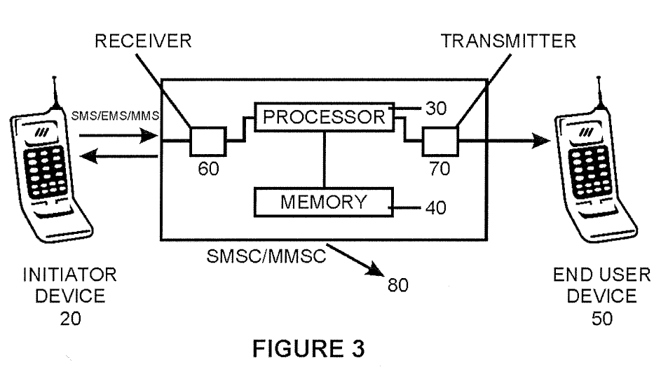

FIG. 3 shows the various components of the telecommunication system according to one of the embodiments of the present invention.

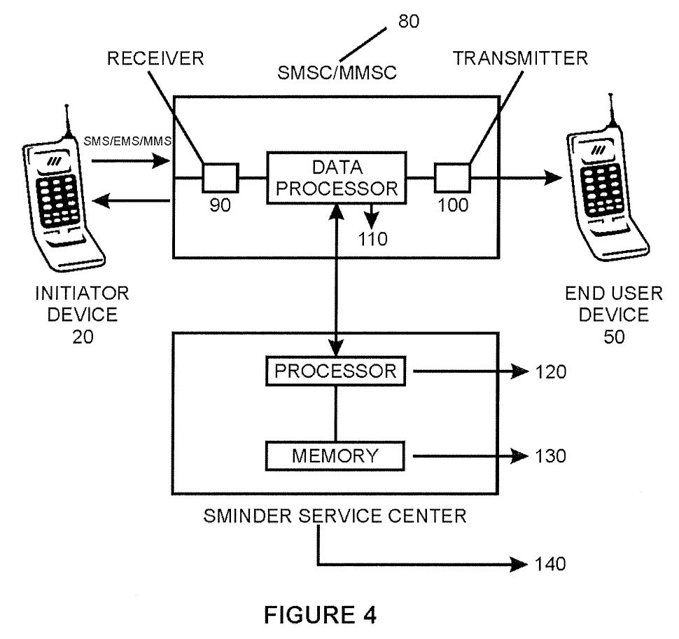

The processor 30 and the memory 40 are coupled to each other and they form part of the said SMSC/MMSC. The said SMSC/MMSC comprises a receiver 60 and a transmitter 70, which are operatively connected to the processor 30 present within the SMSC/MMSC. The receiver 60 receives the message from the initiator device 20 and sends it to the processor 30 for processing and allocation of unique identification number. The processor 30 is configured to allocate a unique identification number to each of the message received by the SMSC/MMSC 80. On allocation of unique number to the message, the processor generates a confirmation message to be sent to the initiator device. The message along with the unique identification number is sent from the receiver 60 to the initiator device 20 so that he may use it for further purposes such as: for reviewing the pending messages, for modifying the messages or for deleting the existing messages. The said message with the date and time of delivery of message is then stored in the memory 40 present within the SMSC/MMSC 80 till the date and time of delivery of the message occurs. Finally, the message is delivered to the end user device 50 at the date and time defined by the initiator through the transmitter 70 connected to the processor 30. Now, in accordance with another scenario of the present invention, as described in FIG. 4, the processor 120 and memory 130 form part of the Service Center 140 being known as SMINDER Service Center. Herein, a data processor 110 is present which is in communication with the receiver 90 which are embedded into the SMSC/MMSC 80. The data processor 110 when receives the message from receiver 90, it communicates the same to the processor 120 contained within the SMINDER Service Center 140. The processor 120 on receiving the said message is responsible for allocating a unique identification number to the message and generating a message incorporating the unique identification number and transmitting the same to the data processor 110 present in the SMSC/MMSC. The confirmation message along with the unique identification number is sent to the initiator device 20 through the transmitter in communication with the data processor 110. The memory 130 present within the Service Center 140 stores the message along with the date and time of delivery of the message till the date and time of delivery of the message occurs. Finally, when the message is to be delivered i.e. at the desired date and time, the processor 120 in the Service Center transmits the message to the data processor 110 which finally sends the message to the end user device 50 through the transmitter 100.

The communication between the data processor 110 contained in the SMSC/MMSC 80 and the processor 120 in the Service Center 140 is based on one or more of the web based protocols. The data processor 110 contained in the SMSC is configured to convert the message in the web based format to be transmitted over Web based protocols such as: HTTP, S-HTTP, SMPP etc and vice versa i.e. the processor 120 in the Service Center 140 converts the web based message into a normal message so that it can be transmitted to the end user in an original format.

The telecommunication system described in the present invention also enables displaying the stored messages on the World Wide Web which is accomplished by communication between the processor present in the SMSC/MMSC or Service Center and a Web Server. The Web Server is connectable to the initiator device for receiving further messages. The messages received can be through a personal mobile number or through Internet and they can be new messages, amendments to the original messages already sent to the SMSC/MMSC for delivery to the end user devices etc.

Advantageously, embodiments of the present invention allow the subscribers to send messages at a predetermined time. For example, an initiator could enter a message reminding him of a meeting or some other event such as a festival prior to its occurrence. The kinds of reminders that he may receive may consist of:
Birthday reminders
Meetings/appointment reminders
Reservation reminders
Event reminders
Product reminders (new product pick up, product repair pick up car pick up, etc.)
Key due date reminders (taxes, licenses, bills, subscriptions, etc.)
Information reminders (news, travel, stocks, etc.)

The invention also enables the system to send messages created by the system as the existing service providers such as:
Festival wishes (New Year, Christmas, etc.)
Special wishes (new born, promotions, new home, anniversary, etc.)
Invitations (parties, wedding, office dinners, etc.)

As will be recognized by those skilled in the art, the innovative concepts described in the present application can be modified and varied over a wide range of applications. Accordingly, the scope of the patented subject matter should not be limited to any of the specific exemplary teachings discussed.

We claim:

1. A method for delivering a Short Messaging Service (SMS) message and/or a Multimedia Messaging Service (MMS) message and/or an Enhanced Messaging Service (EMS) message from an initiator device to an end user device, said method comprising the steps of:
(a) receiving by a short message service centre (SMSC) the SMS and/or the EMS message and/or receiving by a Multimedia Messaging service centre (MMSC) the MMS comprising a service code and a user-defined date and time for delivering the message to said end user device from the initiator device;
(b) allocating an unique identification number to the message thus received in step (a);
(c) sending a message to the initiator device incorporating at least the unique identification number;
(d) storing the message with at least the unique identification number, thereby creating a stored message; and
(e) delivering by the SMSC/MMSC the message at said user-defined date and time to the end user device.

2. The method as claimed in claim 1 wherein in step (b), the unique identification number is allocated by the SMSC/MMSC or by a Service Centre (SC) operatively coupled to the SMSC/MMSC.

3. The method as claimed in claim 2, wherein if the unique identification number is allocated by the Service Centre, the step of allocating identification number comprises the steps:
(a) transferring the SMS and/or the MMS and/or the EMS message from the SMSC/MMSC to the SC;
(b) allocating the unique identification number to the message by the Service Centre;
(c) generating a message incorporating at least the unique identification number by the Service Centre; and
(d) transmitting the message thus generated in step (c) to the SMSC/MMSC.

4. The method as claimed in claim 3, wherein communication between the SMSC/MMSC and SC are based on one or more of the Web based protocols.

5. The method as claimed in claim 2, wherein if the unique identification number is allocated by the SMSC/MMSC, the step of sending a message to the initiator incorporating at least the unique identification number further comprises the step of generating the message incorporating at least the unique identification number by the SMSC/MMSC.

6. The method as claimed in claim 1, wherein in step (d), the message with at least the unique identification number is stored at the SMSC/MMSC or at the SC.

7. The method as claimed in claim 6, wherein messages thus stored are categorized on the basis of the initiator device.

8. The method as claimed in claim 1, further comprising the step of displaying the message thus stored at the SMSC/MMSC or at the SC.

9. The method as claimed in claim 7, wherein the message thus stored at the SMSC/MMSC or at the SC is displayed on World Wide Web.

10. The method as claimed in claim 7, wherein the messages displayed on the World Wide Web are categorized on the basis of the initiator device.

11. The method as claimed in claim 10, wherein the messages are displayed to be contained in a outbox waiting to be delivered, the outbox being initiator device specific.

12. The method as claimed in claim 1, before step (e) further comprises the step of receiving instruction for amending the stored message, thereby creating an amended message.

13. The method as claimed in claim 12, wherein the instruction for amending the stored message is receivable from the same initiator device or a device which different from the initiator device.

14. The method as claimed in claim 12, wherein the instruction for amending the stored message is accompanied by the unique identification number of the stored message.

15. The method as claimed in claim 12, further comprising the step of storing the amended message and deleting an original message.

16. The method as claimed in claim 12, further comprising delivering the amended message by the SMSC/MMSC at said user-defined date and time to the end user device.

17. The method as claimed in claim 12, wherein if an instruction for deleting an original message is received the stored message is deleted in place of step (e).

18. A telecommunication system for delivering a Short Messaging Service (SMS) message and/or a Multimedia Messaging Service (MMS) message and/or an Enhanced Messaging Service (EMS) message from an initiator device to an end user device, said telecommunications system comprising:
a Short Messaging Service Center (SMSC) for receiving the Short Messaging Service (SMS) message and/or an Enhanced Messaging Service (EMS) message and/or a Multimedia Messaging Service Center for receiving the Multimedia Messaging Service (MMS) message from an initiator device; for sending a confirmation message to the initiator device with at least an unique identification number and for delivering the message at the user defined date and time to the end user device;
a processor configured for allocating the unique identification number to the message thus received by the said SMSC/MMSC; and
a memory for storing the said message with at least the unique identification number until the said user defined date and time is reached;
wherein the processor and the memory are in operational communication with the SMSC/MMSC.

19. The telecommunication system as claimed in claim 18, wherein the processor and the memory form part of the said SMSC/MMSC.

20. The telecommunication system as claimed in claim 19, wherein the SMSC/MMSC comprises at least one receiver for receiving the said message from the initiator device and at least one transmitter for transmitting the said message to the end user device and for transmitting the message incorporating the unique identification number to the initiator device, said receiver and transmitter being in operational communication with the said processor which generates the message incorporating the unique identification number.

21. The telecommunications system as claimed in claim 18, wherein the processor and the memory form part of a Service Center (SC) which is in communication with the said SMSC/MMSC.

22. The telecommunication system as claimed in claim 21, wherein the SMSC/MMSC comprises:
at least one receiver for receiving the message from the initiator device;
a data processor in communication with the receiver for receiving the said message, communicating the same to the processor contained in the Service Center and in response receive the message incorporating the unique identification number from the Service Center; and
a transmitter in communication with the data processor for transmitting the message incorporating the unique identification number to the initiator device.

23. The telecommunication system as claimed in claim 22, wherein the communication between the data processor contained in the SMSC/MMSC and the processor contained in the SC is based on one or more web based protocols and the data processor contained in the SMSC/MMSC is configured to convert the Short Messaging Service (SMS) message and/or a Multimedia Messaging Service (MMS) message and/or an Enhanced Messaging Service (EMS) message into a web based message and vice versa.

24. The telecommunication system as claimed in claim 18, wherein the processor is in communication with a web server for displaying the message thus stored at the SMSC/MMSC or at the SC on the World Wide Web.

25. The telecommunication system as claimed in claim 24, wherein the Web Server is connectable to the initiator device for receiving further messages.
